(19) United States
(12) Patent Application Publication
(10) Pub. No.: US 2006/0266421 A1
(43) Pub. Date: Nov. 30, 2006

(54) Check valve

(76) Inventors: Kevin Chilvers, Norfolk (GB); Stephen Mark Dyble, Norfolk (GB); Richard Warby, Wisbech (GB); Mike McDonnell, Dereham (GB)

Correspondence Address: SMITH, GAMBRELL & RUSSELL, 1850 M STREET, N.W., SUITE 800, WASHINGTON, DC, 20036, US

(21) Appl. No.: 11/397,903

(22) Filed: Apr. 5, 2006

(30) Foreign Application Priority Data
Apr. 8, 2005 (GB) 0507169.1

(51) Int. Cl. F16K 15/00

(52) U.S. Cl. 137/515

(57) ABSTRACT

A check valve suitable for use with a sealing sleeve, the check valve comprising: a body defining a bore having a first open end adapted for connection with a dispensing apparatus and a second open end adapted for connection with a delivery apparatus; a core slidable in the bore between a closed position and an open position; sealing means for sealing between the body and the core when the core is in the closed position, so as to prevent flow of fluid between the first and second open ends; biasing means for biasing the core into the closed position; the distal end of the second open end being provided with a first flange which extends radially beyond the outer edge of the body. Wherein the first flange is provided with one or more surfaces which are substantially non-perpendicular to each other.

This invention relates to check valves. In particular, it relates to medical check valves suitable for use in the insertion or removal of fluids—being liquids or gases—into or out of animals or humans. More particularly, the invention relates to a check valve for use with a sealing sleeve.

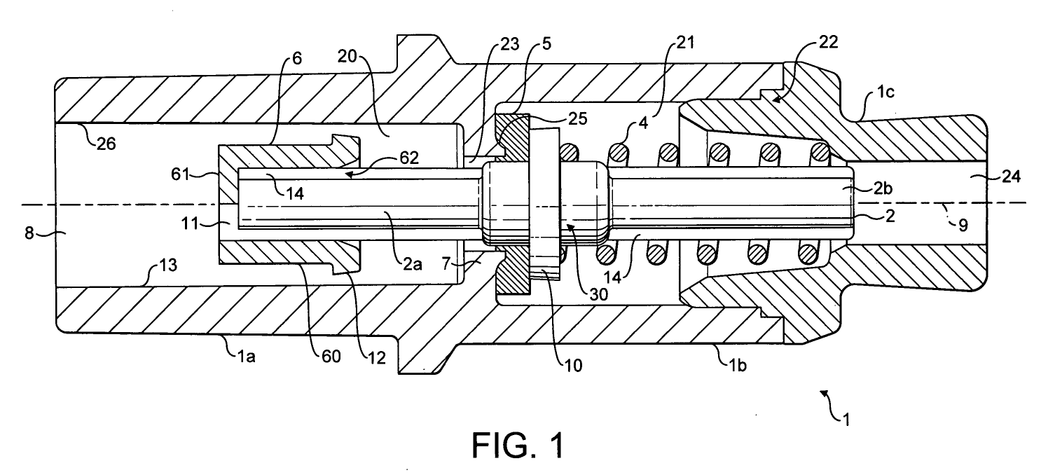

Check valves, in general, are known in the art. One example is shown in FIG. 1. This check valve comprises a hollow body 1 housing a core 2, a spring 4, a seat 5 and an adaptor 6. The body 1 is designed to be connected to a syringe from the rearward side (left hand side as shown), and to a tube on the forward side (right hand side as shown) as described below. The valve provides a seal at the end of the tube, whilst also allowing fluid to be inserted or removed from, or into, the syringe.

The body 1 comprises a cap 1c and a generally cylindrical part having a first portion 1a of smaller cross-sectional area and a second portion 1b of larger cross-sectional area. A flange 7 (here onwards known as the third flange 7) extends inwardly from the interior surface of the body 1 and defines an aperture 23, which delineates the first portion 1a from the second portion 1b. The forward facing surface of the third flange 7 is provided with a rim 25. The second portion 1b is at a forward end of the body 1. The first portion 1a is at a rearward end of the body 1.

The cylindrical part 1a,1b of the body 1 is hollow and comprises an open end 8 at the rearward end of the body 1 and an open end 22 at the forward end of the body 1. A continuous bore 20,21 runs from open end 8 to open end 22, via aperture 23. The diameter of bore 20 is smaller than that of bore 21. The cap 1c is received in bore 21 in the open end 22 of the body 1 in a sealing manner. A through bore 24 is formed in the cap 1c allowing fluid to pass through the cap 1c.

The rear-most portion of bore 20 is tapered with a Luer taper 26 to BS EN 20594. The inner diameter of bore 20 thus slightly decreases towards the second portion 1b of the body 1.

The core 2 is contained within the body 1 and comprises a generally cylindrical member having an enlarged-diameter mid-portion 30. The core 2 is symmetrical about a transverse axis at its midpoint. The enlarged mid-portion 30 is provided with an outwardly-directed flange 10 (here onwards known as the fourth flange 10). The core 2 is further provided with an annular seat 5 which is abutted against the rearwardly facing surface of the fourth flange 10. The internal diameter of the seat 5 is chosen so as to form an interference fit on the enlarged mid-portion 30 so that, in use, the seat 5 moves with the mid-portion 30. The core 2 is located in bore 20,21 with the fourth flange 10 in bore 21. The core 2 is biased rearwardly by means of a spring 4 which extends between cap 1c and a forward-facing surface of flange 10. The spring 4 biases the seat 5 into sealing contact with the rim 25 of the third flange 7. End portions 2a and 2b of the core 2 are provided with flutes 14 running longitudinally from the distal ends of the core 2 to the enlarged mid-portion 30.

The adaptor 6 is mounted on the rearward end of end portion 2a of the core 2 within bore 20. The adaptor 6 comprises a cylindrical body 60 having a closed rear end 61 and an open forward end 62 which is received over the distal end of end portion 2a. The closed rear end 61 comprises an aperture 11. The open end 62 is provided with an outwardly flared rim 12.

In the use of the known valve, a nozzle of a Luer syringe is inserted into bore 20. The nozzle is of a diameter such that, as it is inserted, the Luer taper 26 ensures that the syringe seals in a fluid-tight manner with the body 1. As the syringe nozzle is pushed forwards it contacts the closed end 61 of the adaptor 6 with the aperture of the syringe nozzle at least partially aligned with aperture 11 in the adapter 6. Movement of the syringe propels the adaptor 6, core 2 and seat 5 forwardly, against the biasing of the spring 4. As the core 2 moves forwardly, the seat 5 and flange 10 lose contact with rim 25 breaking the seal formed therebetween. The syringe is then enabled to dispense fluid through the check valve. The dispensed fluid passes through the aperture 11 into the flutes 14 of the end portion 2a of the core 2. The fluid is forced along the flutes 14 and then through aperture 23 and between the flange 7 and seat 5 into bore 21. The fluid is then free to move along bore 21 and through the bore 24 of cap 1c. The fluid then passes into a connecting tube (or other delivery apparatus attached to the check valve) to flow into the human or animal to inflate a cuff or balloon on a medical device. When the syringe is withdrawn from the check valve, the spring 4 urges the core 2 rearwardly until the seat 5 and flange 7 contact the rim 25, resealing the valve. The core 2 may also be urged rearwardly by back pressure from the delivery apparatus.

It is discussed in the applicant's co-pending applications (UK 0327611.0 and PCT/GB2004/005022) how the adaptor 6 may be removed and modifications be made to the core. The subject-matter of those applications is incorporated by reference.

It is known in the art to further secure the delivery apparatus to the check valve using a sealing sleeve. Once a delivery apparatus has been placed over the forward side of the check valve, a sealing sleeve may be slid on to the check valve from the rearward side to cover a part of the delivery apparatus. The sealing sleeve in this position provides a friction fit on the delivery apparatus between itself and the check valve.

Owing to the nature of use of check valves, often, in the treatment of humans and animals, it is essential that a good connection is made between a delivery apparatus—at one end of the check valve—and a dispensing apparatus—at the other end of the check valve. Often, the dispensing apparatus is a Luer syringe and this forms a good connection with the check valve. However, at the other end, the check valve may be connected to various types of tube (delivery apparatus) made of, for example, silicone or latex. As it is equally important, if not more so, that the check valve, is securely connected to the tube, this invention proposes a check valve, for use with a sealing sleeve, which it is envisaged will provide an improved secure connection between the check valve and the delivery apparatus. Further, such an improved connection must not be at the sacrifice of the assembled check valve. In other words, the fastening/assembly of the check valve and sleeve with the delivery apparatus should not substantially damage or weaken the check valve.

Accordingly, in a first aspect the invention provides a check valve for use with a sealing sleeve, the check valve comprising:

a body defining a bore having a first open end adapted for connection with a dispensing apparatus and a second open end adapted for connection with a delivery apparatus;

a core slidable in the bore between a closed position and an open position;

sealing means for sealing between the body and the core when the core is in the closed position, so as to prevent flow of fluid between the first and second open ends;

biasing means for biasing the core into the closed position;

the distal end of the second open end being provided with a first flange which extends radially beyond the outer edge of the body and wherein the first flange is provided with one or more surfaces which are substantially non-perpendicular to each other.

The one or more surfaces may be provided adjacent an outer surface of the first flange and are, preferably, located adjacent or on the circumferential surface thereof.

In a preferred embodiment, the one or more surfaces provide a smaller diameter portion, at a leading edge of the first flange, for a sealing sleeve to circumvent during assembly, and a larger diameter portion, to provide an enhanced fastening and retention of a delivery apparatus.

The check valve may comprise one or more sets of two substantially non-perpendicular surfaces separated by a substantially perpendicular surface.

Most preferably, the one or more surfaces may comprise a frustro-conical portion, a convex portion, a truncated convex portion and/or castellations.

In a further embodiment the first flange may comprise a portion against which the biasing means is biased.

Additionally, the first flange is affixed to the second open end by ultrasonic welding, although any suitable method known in the art may be used.

In an alternative embodiment, the check valve may comprise a hollow cap located at the distal end of the second open end. In particular the hollow cap may comprise the first flange and the one or more surfaces, such that, the hollow cap is provided with hollow portions on each side of the first flange, a first hollow portion of the cap being sized to interact with the internal diameter of the second open end.

Additionally, and preferably, the first flange is provided as an injection moulding with the hollow portions to form the cap, the cap being secured to the second open end by ultrasonic welding, although any suitable method known in the art may be used.

Further, the cap may provide a portion against which the biasing means is biased.

Most preferably, the frustro-conical portion and truncated convex portion provide a smaller diameter portion leading edge of the first flange and a larger diameter portion following edge of the first flange.

In addition, the frustro-conical portion and truncated convex portion may be partially-, but temporarily, collapsible or substantially fully-, but temporarily, collapsible during sliding on of a sealing sleeve.

Most preferably, the convex portion provides a smaller diameter portion leading edge of the first flange, a larger diameter mid-portion of the first flange and a smaller diameter portion following edge of the first flange, so as to provide uniform retention pressure on a delivery apparatus.

Further preferably, the castellations are provided around the circumferential surface of the first flange and allow displacement of a delivery apparatus into the indentations of the castellations, during sliding on of a sealing sleeve.

Advantageously, the check valve further comprises a second flange located at around a mid-portion of the body.

In particular, the delivery apparatus is a catheter tube and the dispensing apparatus is a syringe.

Additionally, the core is a one-piece core having a first portion extending towards the first open end of the body, a second portion extending towards the second open end of the body and a third flange intermediate the first and second portions; wherein a distal end of the first portion of the core comprises one or more passageways for allowing fluid communication between a dispensing apparatus, to which the check valve is connected in use, and the bore when the dispensing apparatus is brought into direct engagement with the distal end of the first portion of the one-piece core, to propel the core from the closed position to an open position. Preferably, the distal end of the first portion of the core comprises a cruciform cross-section, or a single strip or slot.

Preferably, the check valve further comprises a sealing sleeve.

The sealing sleeve may be a cylinder having an open end for sliding on to over the check valve and a delivery apparatus, the open end being further provided with an outwardly flared rim.

In addition, the second end of the sealing sleeve is provided with an aperture through which the first open end of the check valve can pass, when the sealing sleeve is slid over the check valve, and where the second flange is abutted by the second end of the sealing sleeve.

Most preferably, the sealing sleeve is provided with co-operating portions which co-operate with a surface of a delivery apparatus which has been displaced by the one or more surfaces of the first flange. Further preferably, the co-operating portions are indentations shaped to indirectly co-operate with the one or more surfaces of the first flange, the one or more surfaces of the first flange comprising a frustro-conical portion, a convex portion, a truncated convex portion and/or castellations.

In a second aspect of the present invention, there is provided a method of fastening (or assembly of) a check valve, as described above, to a delivery apparatus, the method comprising locating the delivery apparatus over the first flange and second open end of the check valve up to, and, optionally, but not including, the second flange, and sliding on a sealing sleeve over the first open end of the check valve, such that an open end of the sealing sleeve slides easily over the delivery apparatus in the region of the one or more surfaces of the first flange, until a second end of the sealing sleeve abuts the second flange.

Most preferably, the sealing sleeve is provided with co-operating portions which co-operate with a surface of the delivery apparatus which has been displaced by the one or more surfaces of the first flange.

Advantageously, the co-operating portions are indentations shaped to co-operate with one or more surfaces of the first flange, the one or more surfaces of the first flange comprising a frustro-conical portion, a convex portion, a truncated convex portion and/or castellations.

Advantageously, the present invention allows ease of fastening/assembly of a delivery apparatus to the check valve and sealing sleeve. In particular, once the delivery apparatus has been located over, at least, the first flange, the sealing sleeve is relatively easily slid on to the check valve and over the delivery apparatus—owing to the shape of the one or more surfaces—in the region where the delivery apparatus is displaced by the one or more surfaces of the first flange. Most advantageously, the assembly stresses on the first flange are reduced so that it is not damaged or weakened by locating the delivery apparatus onto the check valve and sliding on the sealing sleeve. Further, compressive forces on the delivery apparatus between the sealing sleeve and first flange are reduced during assembly/fastening of the delivery apparatus.

Further, owing to the invention, in particular, the arrangement of the first flange extending radially beyond the outer edge of the body and the one or more surfaces thereon and the sealing sleeve, a delivery apparatus is securely connected to the check valve. In particular, the present invention provides an improved retention force on the delivery apparatus.

In order that the invention may be fully disclosed, embodiments will now be described, by way of example only, with reference to the accompanying drawings, in which:

FIG. 1 is a longitudinal section of a known prior art check valve;

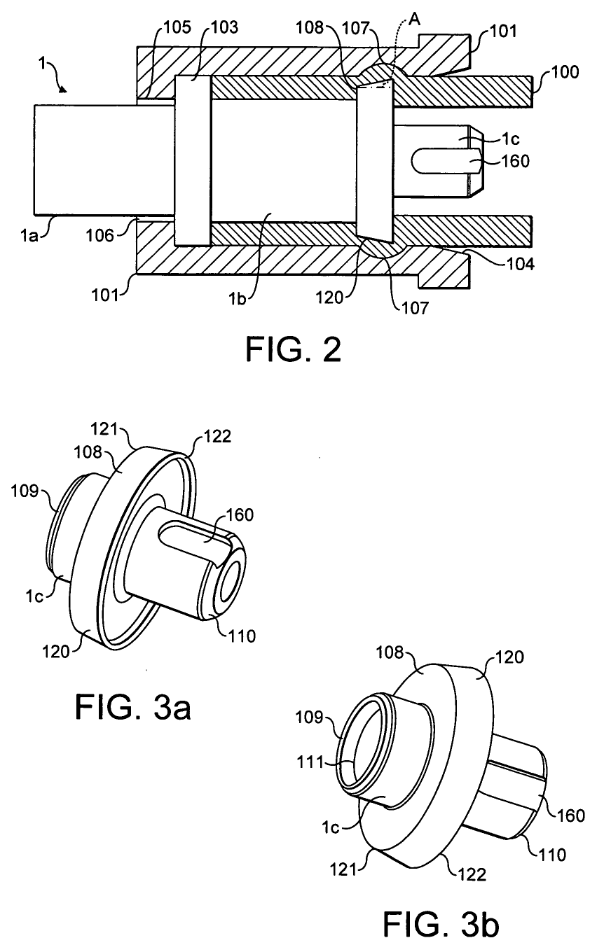

FIG. 2 is a part-cross-sectional view of a first embodiment of check valve of the present invention;

FIGS. 3a and 3b are perspective views of a cap of FIG. 2;

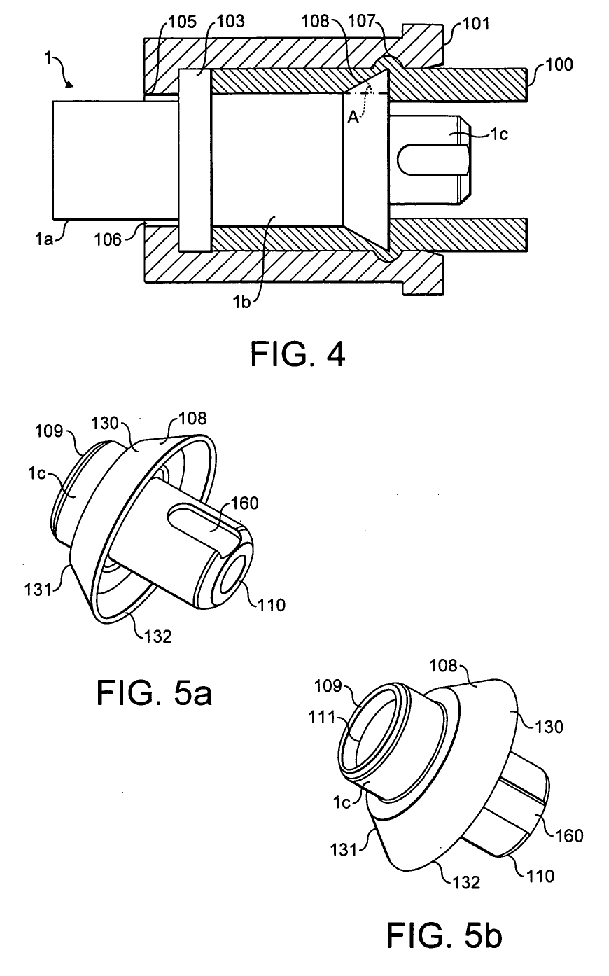

FIG. 4 is a part-cross-sectional view of a second embodiment of check valve of the present invention;

FIGS. 5a and 5b are perspective views of a cap of FIG. 4;

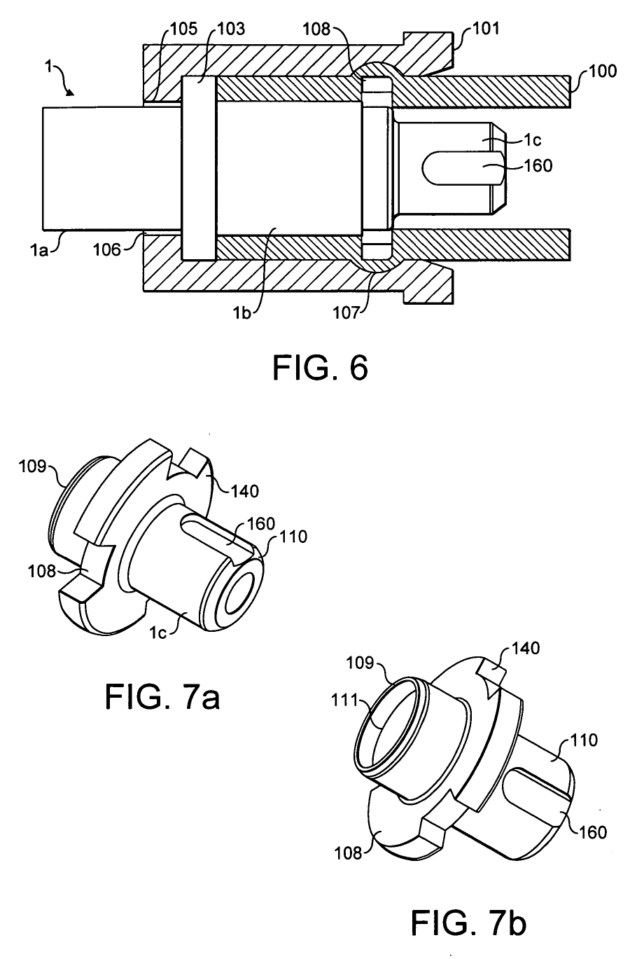

FIG. 6 is a part-cross-sectional view of a third embodiment of check valve of the present invention;

FIGS. 7a and 7b are perspective views of a cap of FIG. 6;

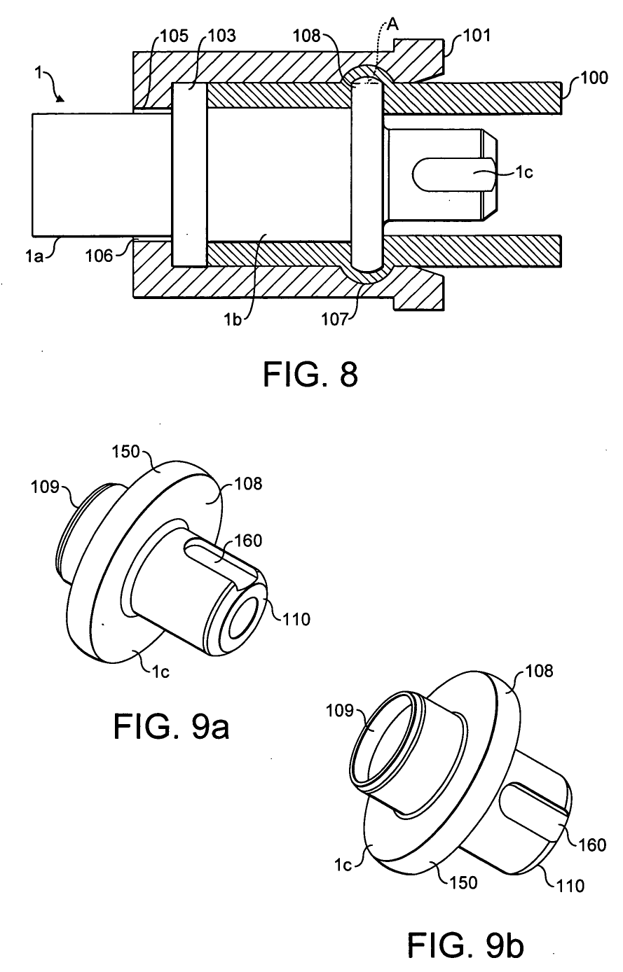

FIG. 8 is a part-cross-sectional view of a fourth embodiment of check valve of the present invention; and

FIGS. 9a and 9b are perspective views of a cap of FIG. 8.

In the description and claims, the term leading edge is used to describe the edge of the first flange which is first circumvented by the sealing sleeve when the sealing sleeve is slid on to the check valve from the rearward side. The term following edge is used to described the second edge of the first flange which is circumvented by the sealing sleeve during sliding on of the sealing sleeve.

Naturally, it will be understood that the terms smaller diameter and larger diameter, as used in the description and claims, are terms which are relative to one another.

In each of the Figures, like numbering has been utilised to identify similar or identical aspects. FIGS. 2, 4, 6 and 8 show—in addition to the check valve shown in FIG. 1—a catheter tube 100 and a catheter valve retaining device 101 (CVRD—sealing sleeve 101). In addition, the body 1 is provided with a flange 103 (hereinafter referred to as the third flange 103) located intermediate portions 1a and 1b. The CVRD 101 is an open-ended cylinder and is provided with an outwardly flared rim 104, which provides an enlarged opening to the open end. The other end of the CVRD 101 is provided with an aperture 105, through which the body portion 1a can pass when the check valve is fastened to a catheter tube 100. A clearance 106 is provided between the CVRD 101 and the body portion 1a. Further, the CVRD 101 is provided with an indent 107 located in the inner surface of the CVRD 101 and where the indent forms a radial channel which extends around the inner circumference of the CVRD 101. In the embodiment shown in the drawings, the channel is substantially concave. However, other shape-profiles of channels may be used depending upon the shape of the flange 108.

The cap 1c is hollow and is provided with a flange 108 (first flange). The cap 1c is also provided with an inner portion 109 and an outer portion 110 which define a single bore through both portions and the flange 108. The inner portion 109 (first hollow portion) is sized to interact with the internal diameter of body portion 1b of the check valve. The inner portion 109 may also comprise an abutment surface 111 against which the biasing means (spring) 4 is biased to close the check valve.

During fastening of a catheter tube 100 to the check valve, the tube 100 is, typically, spread with spreaders and the cap 1c, including the flange 108, and body portion 1b are placed into the spread tube up to, but not including, the flange 103. By removing the spreaders, the tube 100 grips the body portion 1b and cap 1c of the check valve. A CVRD 101 is then slid on to the check valve and over the third flange 103 from the rearward side of the check valve to the forward side so that the body portion 1a enters the aperture 105 and the open end of the CVRD slides easily over the first flange 108 until the non-open end of the CVRD 101 abuts the third flange 103 and the concave channel 107 aligns with the flange 108. Although it is described how the CVRD 101 slides easily over the flange 108, it will be appreciated that a certain amount of force is required.

FIGS. 3a and 3b show a cap 1c having a semi-rigid frustro-conical surface 120 located at the circumferential surface of the flange 108. As can be seen in FIG. 3a, the surface 120 is provided with a smaller diameter leading edge 121 and a larger diameter following edge 122. The following edge may be provided with a cut-out segment, which cut-out segment is disc-shaped and allows the following edge 122 to be resilient. Accordingly, when a CVRD 101 is slid over the flange 108 and the catheter tube, the flared rim 104 of the CVRD 101 at first come into contact with the catheter tube covering the leading edge 121 and, as further force is applied to the CVRD, the CVRD is caused to displace radially to travel around/circumvent the widening diameter of the surface 120. Additionally, and typically, a compressive force is exerted on the catheter tube 100 surrounding the flange 108.

FIGS. 5a and 5b show a cap 1c having a frustro-conical surface 130 similar to the surface 120 shown in FIGS. 3a and 3b, which has a leading edge 131 and a following edge 132. However, the surface 130 is substantially wholly collapsible and resilient and is displaceable by sliding on of the CVRD 101. During sliding on of the CVRD 101, the surface 130 displaces and flattens to allow the CVRD 101 to be easily slid over the catheter tube 100 surrounding the flange 108. As the CVRD is slid further on to the check valve, the convex channel 107 comes in to line with the surface 130, allowing the surface to resiliently return substantially to its normal un-flattened position.

FIGS. 7a and 7b show a cap 1c having a castellated surface 140. The surface 140 is, therefore, provided with indentations 141 into which the catheter tube may deflect or displace during sliding on of the CVRD 101, as described above.

FIGS. 9a and 9b show a cap 1c having a convex surface 150. The flange 108 is provided with a smaller diameter leading edge 151, a larger diameter mid-portion 152 of the surface 150 and a smaller diameter following edge 153. The arrangement of this convex surface 150 provides a very similar result to the semi-rigid frustro-conical surface 120. In addition, once a CVRD 101 is fastened in position on to the check valve and catheter tube, co-operation of the concave channel 107 and the convex surface 150 provide a substantially equal compressive retention force on the catheter tube 100 held therebetween.

As shown in the drawings, the one or more surfaces are substantially non-perpendicular and may be arranged at an angle A from a notional perpendicular surface of the flange 108. In particular, the angle A may be from 5 degrees to 60 degrees and, preferably, from 10 degrees to 45 degrees. By arranging the one or more surfaces at an angle A from a notional perpendicular surface of the flange 108, the disclosed advantages of the invention are provided.

The core and body may be formed of any suitable engineering plastic such as polyester, nylon, acetal, polyethylene (PE), polypropylene (PP), polycarbonate (PC), polybutylene terephthalate (PBT), acrylonitrile-butadiene-styrene (ABS), polyvinyl chloride (PVC), or similar. The seat of the core may be formed from any suitable material having acceptable performance characteristics. Preferred examples include nitrile, EPDM and other thermoplastic elastomers, butyl and neoprene.

Preferably, the cap 1c of the present invention is injection moulded. In particular, the cap 1c is formed by injection moulding of the flange 108, the inner portion 109 and the outer portion 110 in one piece. Each cap 1c is provided with a key way/flute where the gate is located for tooling purposes. Additionally, as mentioned previously, the cap 1c, once the inner portion 109 is placed within the end of the body portion 1b, is welded to the body portion 1b by ultrasonic welding.

In an alternative, a different flange arrangement (not shown) may be provided which provides an abutment 11 against which the spring means can be biased. In this arrangement, a flange provided with a hole for liquid flow comprises the surfaces of the invention and may be used instead of the cap 1c. The flange may be welded directly to the body portion 1b. This welded joint is preferably made by ultrasonic welding.

Advantageously, as the CVRD 101 slides relatively easily over the flange 108 where the flange 108 is displaced by the catheter tube 100—owing to the claimed surfaces—lateral stress on the flange is reduced during the assembly or fastening of a catheter tube to the check valve using a sealing sleeve. Furthermore, a secure connection of the check valve to the catheter tube 100 is provided without weakening or over stressing the welded joints of the cap and body 1b. In addition, the claimed surfaces of the flange are designed in such a manner as to reduce the assembly stresses on the welded joint between the cap 1c and the body 1b and, thus, this enables the first flange 108 to be manufactured with increased dimensions. For example, closer tolerance to or interferences with the open end of the CVRD 101 is provided, including, an increased compression on the catheter tube 100 by the indent 107.

Whilst above the cylindrical body 1 is circular in cross-section, it could be any cross-sectional shape.

The above description refers to the check valve for use with fluid, and it is re-iterated that the fluid may be a gas (for example air) or a liquid. The check valve may also be used to deliver or remove fluids directly to or from a human or animal body.

1. A check valve suitable for use with a sealing sleeve, the check valve comprising:
a body defining a bore having a first open end adapted for connection with a dispensing apparatus and a second open end adapted for connection with a delivery apparatus;
a core slidable in the bore between a closed position and an open position;
sealing means for sealing between the body and the core when the core is in the closed position, so as to prevent flow of fluid between the first and second open ends;
biasing means for biasing the core into the closed position;
a distal end of the second open end being provided with a first flange which extends radially beyond the outer edge of the body and wherein the first flange is provided with one or more surfaces which are substantially non-perpendicular to each other.

2. A check valve as claimed in claim 1, wherein the one or more surfaces are provided adjacent an outer surface of the first flange.

3. A check valve as claimed in claim 1, wherein the one or more surfaces of the first flange are located adjacent or on the circumferential surface.

4. A check valve as claimed in claim 1, wherein the one or more surfaces provide a smaller diameter portion, at a leading edge of the first flange, for a sealing sleeve to circumvent during assembly, and a larger diameter portion, to provide an enhanced fastening and retention of a delivery apparatus.

5. A check valve as claimed in claim 1, wherein the check valve comprises one or more sets of two substantially non-perpendicular surfaces separated by a substantially perpendicular surface.

6. A check valve as claimed in claim 1, wherein the one or more surfaces comprise a frustro-conical portion, a convex portion, a truncated convex portion and/or castellations.

7. A check valve as claimed in claim 1, wherein the first flange comprises a portion against which the biasing means is biased.

8. A check valve as claimed in claim 1, wherein the first flange is affixed to the second open end by ultrasonic welding.

9. A check valve as claimed in claim 1, wherein the check valve comprises a hollow cap located at the distal end of the second open end.

10. A check valve as claimed in claim 9, wherein the cap comprises the first flange and the one or more surfaces.

11. A check valve as claimed in claim 10, wherein the hollow cap is provided with hollow portions on each side of the first flange, a first hollow portion of the cap being sized to interact with the internal diameter of the second open end.

12. A check valve as claimed in claim 10, wherein the first flange is provided as an injection moulding with the hollow portions to form the cap, the cap being secured to the second open end by ultrasonic welding.

13. A check valve as claimed in claim 9 wherein the cap provides a portion against which the biasing means is biased.

14. A check valve as claimed in claim 6, wherein the frustro-conical portion and truncated convex portion provide a smaller diameter portion leading edge of the first flange and a larger diameter portion following edge of the first flange.

15. A check valve as claimed in claim 14, wherein the frustro-conical portion and truncated convex portion are partially-, but temporarily, collapsible or substantially fully-, but temporarily, collapsible during sliding on of a sealing sleeve.

16. A check valve as claimed in claim 6, wherein the convex portion provides a smaller diameter portion leading edge of the first flange, a large diameter mid-portion of the first flange and a smaller diameter portion following edge of the first flange, so as to provide uniform retention pressure on a delivery apparatus.

17. A check valve as claimed in claim 6, wherein the castellations are provided around the circumferential surface of the first flange and allow displacement of a delivery apparatus into the indentations of the castellations, during sliding on of a sealing sleeve.

18. A check valve as claimed in claim 1 further comprising a second flange.

19. A check valve as claimed in claim 18, wherein the second flange is located at or around a mid-portion of the body.

20. A check valve as claimed in claim 1, wherein the delivery apparatus is a catheter tube and the dispensing apparatus is a syringe.

21. A check valve as claimed in claim 1, wherein the core is a one-piece core having a first portion extending towards the first open end of the body, a second portion extending towards the second open end of the body and a third flange intermediate the first and second portions; wherein a distal end of the first portion of the core comprises one or more passageways for allowing fluid communication between a dispensing apparatus, to which the check valve is connected in use, and the bore when the dispensing apparatus is brought into direct engagement with the distal end of the first portion of the one-piece core, to propel the core from the closed position to an open position.

22. A check valve as claimed in claim 21, wherein the distal end of the first portion of the core comprises a cruciform cross-section, or a single strip or slot.

23. A check valve as claimed in claim 1, wherein the check valve further comprises a sealing sleeve.

24. A check valve as claimed in claim 23, wherein the sealing sleeve is a cylinder having an open end for sliding on to the check valve, the open end being further provided with an outwardly flared rim.

25. A check valve as claimed in claim 24, wherein a second end of the sealing sleeve is provided with an aperture through which the first open end of the check valve can pass when the sealing sleeve is slid over the check valve, and where the second flange is abutted by the second end of the sealing sleeve.

26. A check valve as claimed in claim 23, wherein the sealing sleeve is provided with co-operating portions which co-operate with a surface of a delivery apparatus which has been displaced by the one or more surfaces of the first flange.

27. A check valve as claimed in claim 26, wherein the co-operating portions are indentations shaped to indirectly co-operate with the one or more surfaces of the first flange, the one or more surfaces of the first flange comprising a frustro-conical portion, a convex portion, a truncated convex portion and/or castellations.

28. (canceled)

29. A method of fastening a check valve, as claimed in claim 1, to a delivery apparatus, the method comprising locating the delivery apparatus over the first flange and second open end of the check valve and, optionally, up to, but not including, the second flange, and sliding on a sealing sleeve over the first open end of the check valve, such that an open end of the sealing sleeve slides easily over the delivery apparatus in the region of the one or more surfaces of the first flange, until a second end of the sealing sleeve abuts the second flange.

30. A method as claimed in claim 29, wherein the sealing sleeve is provided with co-operating portions which co-operate with a surface of the delivery apparatus, which has been displaced by the one or more surfaces of the first flange.

31. A method as claimed in claim 30, wherein the co-operating portions are indentations shaped to correspond to co-operate with the one or more surfaces of the first flange, the one or more surfaces of the first flange comprising a frustro-conical portion, a convex portion, a truncated convex portion and/or castellations.
